(19) United States
(12) Patent Application Publication
(10) Pub. No.: US 2007/0238000 A1
(43) Pub. Date: Oct. 11, 2007

(54) ELECTROLYTE, ELECTROLYTE MEMBRANE, MEMBRANE/ELECTRODE ASSEMBLY AND FUEL CELL POWER SOURCE

(76) Inventors: Toru Koyama, Hitachi (JP); Makoto Morishima, Hitachinaka (JP); Hidetoshi Honbou, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/627,499

(22) Filed: Jan. 26, 2007

(30) Foreign Application Priority Data
Apr. 6, 2006 (JP) 2006-104808

(51) Int. Cl. H01M 8/10; C08J 5/20

(52) U.S. Cl. 429/33; 521/25

(57) ABSTRACT

Sulfoalkyl groups or sulfonic groups as proton-conductive groups, and a phosphoalkyl group as oxidation-resistance imparting groups are introduced into a hydrocarbon electrolyte membrane. A fuel cell is provided wherein the membrane is insoluble in an aqueous methanol solution as a fuel and can stably generate electricity over extended periods of time. Sulfoalkyl groups or sulfonic groups as proton-conductive groups, and phosphoalkyl groups as oxidation-resistance imparting groups are introduced into a hydrocarbon electrolyte, and the resulting hydrocarbon electrolyte is used as an electrolyte of an electrode. A direct-methanol fuel cell (DMFC) is provided wherein the fuel cell is inexpensive and can operate stably over extended periods of time.

### CLAIM OF PRIORITY

The present application claims propriety from Japanese application serial No. 2006-104808, filed on Apr. 6, 2006. the content of which is incorporated by reference into this application.

### TECHNICAL FIELD

The present invention relates to hydrocarbon polymer electrolytes and hydrocarbon polymer electrolyte membranes that are highly durable and insoluble in liquid fuels such as methanol. It also relates to membrane/electrode assemblies, fuel cells, and fuel cell power sources using the same.

### RELATED ART

Direct methanol fuel cells (DMFCs) use an aqueous methanol solution as a fuel, in which methanol and oxygen are fed to an anode and a cathode, respectively; the fed methanol reacts with water in the anode to yield protons; and the protons move in a polymer electrolyte membrane toward the cathode and react with the fed oxygen in the cathode to yield water. Accompanied with this, electrons move in an external circuit connecting between the two electrodes so as to yield electric energy. Electrode reactions in the entire fuel cell are represented by following chemical formulae:

Anode (electrode fed with CH₃OH): CH₃OH+H₂O→CO₂+6H⁺+6e⁻ (1)

Cathode (electrode fed with O₂): 3/2O₂+6H⁺+6e⁻→3H₂O (2)

Entire fuel cell: CH₃OH+3/2O₂→CO₂+3H₂O (3)

Entire fuel cell: 2H₂+O₂→2H₂O (4)

In contrast, certain solid polymer fuel cells use hydrogen as a fuel (polymer electrolyte fuel cells or proton-exchange membrane fuel cells; PEFCs), in which hydrogen and oxygen are fed to an anode and a cathode, respectively; the fed hydrogen is converted into a proton in the anode; the proton moves in a polymer electrolyte membrane to the cathode and reacts with the fed oxygen in the cathode to yield water. Accompanied with this, electrons move in an external circuit connecting between the two electrodes so as to yield electric energy. Electrode reactions in the entire fuel cell are represented by following chemical formulae:

Anode (electrode fed with H₂): H₂→2H⁺+2e⁻ (5)

Cathode (electrode fed with O₂): O₂+4H⁺+4e⁻→2H₂O (6)

Entire fuel cell: 2H₂+O₂→2H₂O (7)

Polymer electrolyte membranes used in related art include fluorine-containing electrolyte membranes typified by a poly(perfluorosulfonic acid); and hydrocarbon electrolyte membranes typified by engineering plastics. Such engineering plastics contain sulfonic group and/or sulfoalkyl groups introduced for imparting proton conductivity. Such hydrocarbon electrolyte membranes can be prepared at low cost and show less crossover of fuel, are thereby advantageous as polymer electrolyte membranes, and have been investigated for practical use.

In an anode of actual fuel cells, a two-electron reduction reaction represented by Formula (8) occurs to yield hydrogen peroxide, in addition to the main electrode reactions.

O₂+2H⁺+2e⁻→H₂O₂ (8)

The hydrogen peroxide yields hydroxyl radical (.OH) as represented by following Formula (9) by the catalysis of a metal ion, such as Fe²⁺ or Cu⁺, derived typically from a pipe.

H₂O₂→2.OH (9)

The formed hydroxyl radical degrades a polymer membrane electrolyte within a short time to cause reduction in thickness or breakage of the membranes. This increases the crossover of the fuel and oxygen and causes a combustion reaction to thereby increase the breakage of the electrolyte membranes. Hydrocarbon electrolyte membranes, if used as electrolyte membranes in proton-exchange membrane fuel cells (PEFCs), undergo deterioration originating in the anode, show decreased output performance and become unable to generate power within several thousands of hours in operation.

To avoid this, a hydrogen-peroxide decomposer or a metal-ion scavenger is incorporated into a polymer electrolyte membrane or into an electrode, or is arranged between a polymer electrolyte membrane and an electrode. The decomposer acts to decompose the formed hydrogen peroxide before being converted into a harmful hydroxyl radical. The scavenger acts to fetch metal ions such as Fe²⁺ and Cu⁺ ions. This technique can be found, for example, in Patent Document 1.

[Patent Document 1] Japanese Unexamined Patent Application Publication (JP-A) No. 2001-118591

### SUMMARY OF THE INVENTION

The present inventors found that direct-methanol fuel cells (DMFCs) using hydrocarbon electrolyte membranes show decreased output voltages and become substantially incapable of generating electricity after several hundreds of hours from the beginning of fuel supply. They analyzed such failures in fuel cells and found that the reduction in thickness and breakage of electrolyte membrane originate in the cathode. In other words, the reduction in thickness and breakage of electrolyte membrane originate in the cathode and tend to increase in degree with an increasing current density.

In contrast to direct-methanol fuel cells (DMFCs), the deterioration of electrolyte membranes in proton-exchange electrolyte fuel cells (PEFCs) originates in the anode and tends to increase with a decreasing current density. Thus, direct-methanol fuel cells (DMFCs) differ from proton-exchange electrolyte fuel cells (PEFCs) in origin and acceleration behavior of deterioration. Accordingly, measures against the deterioration of proton-exchange electrolyte fuel cells (PEFCs) may not be suitably applied to direct-methanol fuel cells (DMFCs) if without modification.

Under these circumstances, the present inventors made investigations on measures against the reduction in output of direct-methanol fuel cells (DMFCs) using hydrocarbon electrolyte membranes, with reference to the measures against the deterioration in proton-exchange electrolyte fuel cells (PEFCs). As a result, they found a possible solution in which sulfonic groups and phosphonic acid groups are introduced into a hydrocarbon polymer electrolyte membrane. Such sulfonic groups and phosphonic acid groups impart proton conductivity and oxidation resistance, respectively, to the membrane.

However, they also found that the resulting hydrocarbon electrolyte membrane becomes more soluble in an aqueous methanol solution as a fuel with an increasing quantity of phosphonic acid groups, and such a methanol-soluble membrane may not be applied to direct-methanol fuel cells (DMFCs).

Accordingly, the present inventors made investigations to provide a technique of introducing a proton-conductive group and an oxidation-resistance imparting group into a hydrocarbon electrolyte membrane and making the resulting hydrocarbon electrolyte membrane insoluble in a fuel aqueous methanol solution. The present invention has been made under these findings.

Specifically, a fuel cell can operate over extended periods of time by introducing a sulfoalkyl group or sulfonic group as a proton-conductive group together with a phosphoalkyl group as an oxidation-resistance imparting group into a hydrocarbon electrolyte membrane.

According to the present invention, a fuel cell uses a hydrocarbon electrolyte membrane being methanol-impermeable or methanol-insoluble and available at low cost. The fuel cell can thereby stably generate electricity over extended periods of time.

### DETAILED DESCRIPTION OF THE PREFERRED EMBODIMENTS

Some embodiments of the present invention will be illustrated below. A proton-conductive group and an oxidation-resistance imparting group can be introduced into a hydrocarbon polymer by any process not specifically limited. Examples of such processes include (1) a process of initially introducing a proton-conductive group into a hydrocarbon polymer to yield a hydrocarbon electrolyte, and introducing an oxidation-resistance imparting group into the hydrocarbon electrolyte; (2) a process of sequentially introducing an oxidation-resistance imparting group and a proton-conductive group in this order into a hydrocarbon polymer; (3) a process of copolymerizing a monomer having a proton-conductive group with another monomer having an oxidation-resistance imparting group; and (4) a process of polymerizing a monomer having both a proton-conductive group and an oxidation-resistance imparting group. Such proton-conductive groups include sulfoalkyl groups and sulfonic group. Among them, sulfoalkyl groups are preferred from the viewpoint of providing both proton conductivity and insolubility in methanol. Of sulfoalkyl groups, typically preferred are sulfopropyl group and sulfobutyl group. The amount of proton-conductive groups is about 0.5 to about 1.8 milliequivalents per gram of dried resin, and more preferably about 0.8 to about 1.5 milliequivalents per gram of dried resin. If the amount of proton-conductive groups is excessively small, the resistance against proton conduction may increase. If it is excessively large, the resulting polymer may become highly soluble typically in an aqueous methanol solution. Oxidation-resistance imparting groups include phosphoalkyl groups. The amount of oxidation-resistance imparting groups is, for example, about 0.5 to about 1.8 milliequivalents per gram of dried resin, and more preferably about 0.8 to about 1.5 milliequivalents per gram of dried resin. If the amount is excessively small, the resulting polymer may not be satisfactorily resistant to oxidation. If it is excessively large, the resulting polymer may become more soluble typically in an aqueous methanol solution.

Hydrocarbon polymers for use in the processes (1) and (2) are not specifically limited, as long as they are thermally stable hydrocarbon polymers. Examples of such hydrocarbon polymers are aromatic hydrocarbon polymers such as poly(ether ether ketone)s, poly(ether ketone)s, poly(phenylene sulfide)s, poly(ether sulfone)s, polysulfones, polybenzimidazoles, polyimides, poly(ether imide)s, and polymer alloys of these polymers.

A sulfoalkyl group may be introduced into a side chain of a hydrocarbon polymer or a polymer alloy thereof by sulfoalkylation. The sulfoalkylation process is not specifically limited and includes, for example, a process of sequentially carrying out halogenoalkylation, acetylthiation, and oxidation of an aromatic ring of a hydrocarbon electrolyte membrane to form a sulfoalkyl; and a process of directly introducing a sulfoalkyl group into an aromatic ring using a sultone. The amount of proton-conductive groups can be controlled by adjusting or selecting, for example, the ratio of an aromatic hydrocarbon polymer to a sulfoalkylating agent, the reaction temperature, the reaction time, and the chemical structure of aromatic hydrocarbon polymer.

A phosphoalkyl group may be introduced into a hydrocarbon polymer by any process. Such processes include, for example, a process of introducing a chloromethyl group into an aromatic ring of a hydrocarbon electrolyte membrane, reacting the introduced chloromethyl group with triethyl ether of phosphonic acid and carrying out hydrolysis.

It is also acceptable to introduce an oxidation-resistant group into a polymer electrolyte previously having a proton-conductive group. This technique is a modification of the above-mentioned process (1). A polymer electrolyte for use herein can be any hydrocarbon electrolytes. Such electrolytes include, for example, electrolytes containing sulfonated engineering plastics such as sulfonated poly(ether ether ketone)s, sulfonated poly(ether sulfone)s, sulfonated acrylonitrile-butadiene-styrene polymers, sulfonated polysulfides, and sulfonated polyphenylenes; electrolytes containing sulfoalkylated engineering plastics such as sulfoalkylated poly(ether ether ketone)s, sulfoalkylated poly(ether sulfone)s, sulfoalkylated poly(ether ether sulfone)s, sulfoalkylated polysulfones, sulfoalkylated polysulfides, sulfoalkylated polyphenylenes, and sulfoalkylated poly(ether ether sulfone)s; and hydrocarbon electrolytes such as sulfoalkyl-etherified polyphenylenes.

Of these, sulfoalkylated hydrocarbon electrolytes and sulfoalkyl-etherified hydrocarbon electrolytes are preferred from the viewpoints of membrane properties such as fuel crossover, ionic conductivity, swelling property, and insolubility in methanol. A fuel cell capable of operating at higher temperatures can be obtained by using a complex electrolyte membrane containing a thermally stable resin and a hydrogen-ion conductive inorganic material finely dispersed therein.

Such proton-conductive inorganic materials include, for example, tungsten oxide hydrates, zirconium oxide hydrates, tin oxide hydrates, silicotungstic acid, silicomolybdic acid, tungstophosphoric acid, and molybdic acid. Such hydrated acidic electrolyte membranes may generally vary in their volume and thereby deform between dryness and wetness.

Even if they have sufficient ionic conductivity, they may have insufficient mechanical strength. In this case, it is effective to use fibers in the form of a nonwoven or woven fabric having excellent mechanical strength, durability, and thermal stability as a core; to add these fibers to electrolyte membranes for reinforcement in the production of the electrolyte membranes; or to use polymer membranes having fine through holes as a core, so as to improve the reliability of cell performance. Membranes including a polybenzimidazole doped with sulfuric acid, phosphoric acid, a sulfonic acid, and/or a phosphonic acid may be used as electrolyte membranes. The resulting electrolyte membranes may become more resistant to fuel permeation.

A polymer electrolyte membrane according to an embodiment of the present invention may further contain additives for use in regular polymers, within ranges not adversely affecting advantages of the present invention. Such additives include, for example, plasticizers, antioxidants, hydrogen peroxide decomposers, metal scavengers, surfactants, stabilizers, and mold releasing agents. The antioxidants include amine antioxidants such as phenol-α-naphthylamine, phenol-β-naphthylamine, diphenylamine, p-hydroxydiphenylamine, and phenothiazine; phenolic antioxidants such as 2,6-di(t-butyl)-p-cresol, 2,6-di(t-butyl)-p-phenol, 2,4-dimethyl-6-(t-butyl)-phenol, p-hydroxyphenylcyclohexane, di-p-hydroxyphenylcyclohexane, styrenated phenols, and 1,1′-methylenebis(4-hydroxy-3,5-t-butylphenol); sulfur-containing antioxidants such as dodecylmercaptan, dilauryl thiodipropionate, distearyl thiodipropionate, dilauryl sulfide, and mercaptobenzimidazole; and phosphorus-containing antioxidants such as tri(norylphenyl)phosphate, trioctadecyl phosphate, tridecyl phosphate, and trilauryl trithiophosphite. The hydrogen peroxide decomposers are not specifically limited, as long as they have catalytic activities for decomposing a peroxide, and include, for example, the antioxidants, as well as metals, metal oxides, metal phosphates, metal fluorides, and macrocyclic metal complexes. Each of these can be used alone or in combination. Among them, preferred are ruthenium (Ru) and silver (Ag) as metals; RuO, WO₃, CeO₂, and Fe₃O₄ as metal oxides; CePO₄, CrPO₄, AlPO₄, and FePO₄ as metal phosphates; CeF₃ and FeF₃ as metal fluorides; and iron-porphyrin, cobalt-porphyrin, hem, and catalase as macrocyclic metal complexes.

Of these, typically preferred are RuO₂ and CePO₄, because they can further satisfactorily decompose peroxides. The metal scavengers can be any substances that can react with a metal ion such as Fe⁺⁺ or Cu⁺⁺ ion to yield a complex, thereby inactivate the metal ion and prevent the metal ion from accelerating the deterioration of membrane. Such metal scavengers include thenoyltrifluoroacetone, sodium diethyldithiocarbamate (DDTC), 1,5-diphenyl-3-thiocarbazone, as well as crown ethers such as 1,4,7,10,13-pentaoxycyclopentadecane and 1,4,7,10,113,16-hexaoxycyclopentadecane; cryptands such as 4,7,13,16-tetraoxa-1,10-diazacyclooctadecane and 4,7,13,16,21,24-hexaoxy-1,10-diazacyclohexacosane; and porphyrins such as tetraphenylporphyrin. The amount of such materials are not limited to those described in the after-mentioned examples. Among them, a combination use of a phenolic antioxidant and a phosphorus-containing antioxidant is preferred, because this combination is effective even in a small amount and less adversely affects the properties of a fuel cell.

These antioxidants, hydrogen peroxide decomposers, and metal scavengers may be added to an electrolyte membrane and electrodes or may be arranged between the membrane and electrodes. These additives are preferably arranged between an electrolyte membrane and a cathode and/or anode. When these additives are arranged in this manner, they exhibit their activities even in a small amount and less adversely affect the properties of a fuel cell.

The thickness of a polymer electrolyte membrane is not specifically limited and is preferably about 10 to about 300 μm, and more preferably about 15 to about 200 μm. A polymer electrolyte membrane preferably has a thickness of 10 μm or more for practically satisfactory strength and preferably has a thickness of 200 μM or less for reducing the resistance of membrane, namely, for improving electricity generation performance. When a membrane is prepared by solution casting, the thickness thereof can be controlled by adjusting the concentration of solution or the thickness of an applied film on a substrate. When a membrane is prepared from a molten material, the thickness of membrane can be controlled by preparing a film having a predetermined thickness according typically to melt pressing or melt extrusion, and drawing (stretching) the film to a predetermined draw ratio.

A binder such as a proton-conductive polymer electrolyte may be used for bonding the polymer electrolyte membrane with carbon particles bearing an anode catalyst, or bonding carbon particles bearing an anode catalyst with each other. As the binder, a polymer electrolyte according to an embodiment of the present invention can be used. In addition, fluorine-containing polymer electrolytes and hydrocarbon electrolytes in related art may be used as the binder. Examples of such hydrocarbon electrolytes for use as a binder include electrolytes of sulfonated engineering plastics such as sulfonated poly(ether ether ketone)s, sulfonated poly(ether sulfone)s, sulfonated acrylonitrile-butadiene-styrene polymers, sulfonated polysulfides, and sulfonated polyphenylenes; electrolytes of sulfoalkylated engineering plastics such as sulfoalkylated poly(ether ether ketone)s, sulfoalkylated poly(ether sulfone)s, sulfoalkylated poly(ether ether sulfone)s, sulfoalkylated polysulfones, sulfoalkylated polysulfides, sulfoalkylated polyphenylenes, and sulfoalkylated poly(ether ether sulfone)s; sulfoalkyl-etherified polyphenylenes; and the above-mentioned hydrocarbon polymers having a proton-conductivity imparting group and an oxidation-resistance imparting group. Among them, preferred are the hydrocarbon polymers having a proton-conductivity imparting group and an oxidation-resistance imparting group, because they are satisfactorily resistant to oxidation and resistant to (insoluble in) an aqueous methanol solution. The amount of proton-conductive groups in the polymer electrolyte is preferably about 0.5 to about 2.5 milliequivalents per gram of dried resin, and more preferably about 0.8 to about 1.8 milliequivalents per gram of dried resin.

The polymer electrolyte membrane as a binder preferably has a sulfonic acid equivalent larger than that of a polymer electrolyte membrane from the viewpoint of ionic conductivity. The amount of oxidation-resistance imparting groups in the polymer electrolyte is preferably about 0.5 to about 2.5 milliequivalents per gram of dried resin, and more preferably about 0.8 to about 1.8 milliequivalents per gram of dried resin. The polymer electrolyte membrane preferably has a sulfoalkyl group and a phosphoalkyl group as a proton-conductivity imparting group and an oxidation-resistance imparting group, respectively, from the viewpoint of proton-conductivity and resistance to (insolubility in) an aqueous methanol solution.

The fluorine-containing polymer electrolytes for use as a binder can be any fluorine-containing electrolytes, such as poly(perfluorosulfonic acid)s. Representative examples thereof include Nafion (registered trademark: E. I. du Pont de Nemours and Company, Wilmington, Del., USA), Aciplex (registered trademark: Asahi Chemical Industry, Co., Ltd., Japan), and Flemion (registered trademark: Asahi Glass Co., Ltd., Japan). These fluorine-containing electrolytes preferably have a sulfonic acid equivalent larger than that of the polymer electrolyte membrane from the viewpoint of ionic conductivity. The electrolyte for use as a binder is preferably a hydrocarbon electrolyte, because such hydrocarbon electrolytes can bond with a hydrocarbon electrolyte membrane satisfactorily.

Such electrolytes for use as a binder may further contain additives for use in regular polymers within ranges not adversely affecting advantages of the present invention. Such additives include, for example, plasticizers, antioxidants, hydrogen peroxide decomposers, metal scavengers, surfactants, stabilizers, and mold releasing agents.

Anode catalysts and cathode catalysts for use herein can be any metals that accelerate or promote the oxidation reaction of a fuel and the reducing reaction of oxygen. Examples of metals are platinum, gold, silver, palladium, iridium, rhodium, ruthenium, iron, cobalt, nickel, chromium, tungsten, manganese, vanadium, titanium and alloys of these metals. Of these catalysts, often used are platinum (Pt) as a cathode catalyst, and a platinum/ruthenium catalyst (Pt/Ru) as an anode catalyst. A metal used as a catalyst may be in the form of particles having particle diameters of generally about 2 to about 30 nm. These catalysts are advantageously supported by carriers such as carbon. Such supported catalysts can be used in smaller amounts and thereby economically advantageous. The amount of a catalyst supported on a carrier arranged in an electrode is preferably about 0.01 to 20 mg/cm².

Electrodes for use in a membrane/electrode assembly include electroconductive materials (electroconductive carriers) bearing fine particles of a catalytic metal and may further include a water repellant and/or a binder according to necessity. Electrodes may also include a catalyst layer and another layer arranged outside the catalyst layer. The other layer contains an electroconductive material bearing no catalyst and may further contain a water repellant and/or a binder according to necessity. The electroconductive material to bear a catalytic metal can be any electroconductive substances and includes, for example, metals and carbon materials. Such carbon materials include, for example, carbon black materials such as furnace black, channel black, and acetylene black; fibrous carbon materials such as carbon nanotubes; activated carbons; and graphite. Each of these can be used alone or in combination.

The water repellant can be, for example, carbon fluoride. The binder is preferably a solution of a hydrocarbon electrolyte of the same kind as the electrolyte membrane for satisfactory adhesion. However, any other resins can also be used. Water-repellent fluorine-containing resins may also be used herein. Examples of such resins are polytetrafluoroethylenes, tetrafluoroethylene-perfluoroalkyl vinyl ether copolymers, and tetrafluoroethylene-hexafluoropropylene copolymers.

A polymer electrolyte membrane and electrodes can be bonded according to any procedure so as to constitute a membrane/electrode assembly for use typically in a fuel cell. A membrane/electrode assembly can be prepared by various processes. It can be prepared, for example, by a process including the steps of mixing an electroconductive material such as catalytic platinum particles supported on carbon with a polytetrafluoroethylene suspension; applying the mixture to a carbon paper; carrying out a heat treatment to yield a catalyst layer; applying a solution, as a binder, of a polymer electrolyte of the same kind as the polymer electrolyte membrane or a fluorine-containing electrolyte to the catalyst layer; and integrating the catalyst layer with the polymer electrolyte membrane by hot pressing. A membrane/electrode assembly may also be prepared by a process of applying a solution of a polymer electrolyte of the same kind as the polymer electrolyte membrane to catalytic platinum particles by coating; a process of applying a catalyst paste to a polymer electrolyte membrane typically by printing, spraying, or an ink-jet process; a process of forming an electrode onto a polymer electrolyte membrane by electroless plating; or a process of allowing a polymer electrolyte membrane to adsorb complex ions of a platinum group metal, and reducing the ions. Among these processes, the process of applying a catalyst paste to a polymer electrolyte membrane by an ink-jet process is desirable, because the catalyst can be used with less loss according to this process.

Direct-methanol fuel cells (DMFCs) may be prepared, for example, in the following manner. Cells (single cells) are initially prepared by arranging a fuel channel plate and an oxidant channel plate outside the membrane/electrode assembly. The fuel channel plate and oxidant channel plate act as current collectors and have channels to constitute a fuel passage and an oxidant passage, respectively. A direct-methanol fuel cell (DMFC) is prepared by stacking a plurality of single cells with the interposition typically of a cooling plate or arraying single cells in one plane so as to connect single cells. Single cells may be connected by stacking or by arraying in one plane, and the arrangement thereof is not specifically limited. For miniaturization and weight reduction of a device using fuel cells, single cells may be arrayed and connected in one plane without using auxiliary mechanisms. Fuel cells are preferably passive fuel cells. They are preferably operated at high temperatures for higher catalytic activity of electrode and for reducing the overvoltage of electrode. However, operation temperatures of fuel cells are not specifically limited. It is also acceptable to operate fuel cells at high temperatures by vaporizing a liquid fuel cell.

A compact power source can be provided by preparing single cells each including an anode, an electrolyte membrane, and a cathode, arraying the single cells in one plane, and connecting the single cells in series through an electroconductive interconnector. The resulting compact power source can yield a high voltage and can operate even without using an auxiliary mechanism for forcedly supplying a fuel and an oxidant and without using an auxiliary mechanism for forcedly cooling fuel cells. By using an aqueous methanol solution having a high volume energy density as a liquid fuel, the compact power source can continuously generate electricity over extended periods of time.

Such compact power sources may be mounted as a power source typically in devices such as mobile phones, notebook-sized personal computers, and mobile video cameras and can drive these devices. They can be continuously used over extended periods of time by sequentially refueling a previously provided fuel.

A compact power source is effectively used as a battery charger by connecting the power source with a charger typically of mobile phones, notebook-sized personal computers and mobile video cameras bearing secondary batteries, and housing the power source within a casing of these devices. This configuration may significantly save the frequency of refueling. Such a mobile electronic device is taken out of the casing and is driven by the action of a secondary battery upon use. After use, the device is housed in the casing, and is thereby connected to the compact fuel cell generator (compact power source) in the casing through the charger so as to charge the secondary battery. By configuring this, a fuel tank may have a larger capacity, and the frequency of refueling can be significantly reduced.

### BRIEF DESCRIPTION OF THE DRAWINGS

FIG. 1 is a diagram of a single cell of a solid polymer fuel cell generator according to an embodiment of the present invention.

FIG. 2 is a graph showing how output voltages vary with time in fuel cells according to an embodiment of the present invention.

FIG. 3 is a diagram of a single cell of a solid polymer fuel cell generator relating to another embodiment of the present invention.

FIG. 4 is a diagram illustrating a fuel cell according to an embodiment of the present invention.

FIG. 5 is a diagram showing a fuel cell power source including a fuel cell using a membrane/electrode assembly according to an embodiment of the present invention.

FIG. 6 is a diagram illustrating a personal digital assistant including a fuel cell power source which includes a fuel cell using a membrane/electrode assembly according to an embodiment of the present invention.

### DETAILED DESCRIPTION OF THE PREFERRED EMBODIMENTS

### EXAMPLES

The present invention will be illustrated in further detail with reference to several examples below, which by no means limit the scope of the present invention.

### Examples 1 to 12

### (1) Preparation of Chloromethylated Poly(Ether Sulfone)s

A 500-ml four-necked round-bottom flask used herein was equipped with a reflux condenser connected with a stirrer, a thermometer, and a calcium chloride tube. After replacing the inner atmosphere of the flask with nitrogen, 30 g of a poly(ether sulfone) (PES) and 250 ml of carbon disulfide were placed in the flask, and chloromethyl methyl ether in the amounts shown in Table 1, a mixture of 1 ml of anhydrous tin(IV) chloride and 20 ml of carbon disulfide was added dropwise thereto, and the resulting mixture was heated and stirred at 46° C. for the reaction time periods in Table 1. Next, the reaction mixture was poured into 1 liter of methanol to precipitate polymers. The precipitates were pulverized using a mixer, were washed with methanol, and thereby yielded chloromethylated polyether sulfones represented by Formula (1):

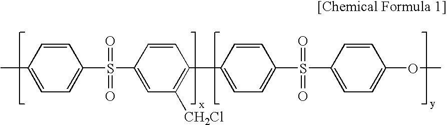

### (2) Preparation of Chloromethylated Diethylphosphomethylated Polyether Sulfones

Each of the chloromethylated poly (ether sulfone) s of Formula (1) was immersed in triethyl ester of phosphonic acid and heated under ref lux for twelve hours. The reaction mixtures were poured into ethanol to precipitate polymers. The precipitates were pulverized in a mixer, were washed with ethanol, and thereby yielded 35 g each of chloromethylated diethylphosphomethylated poly(ether sulfone)s represented by Formula (2). The resulting polymers contain phosphomethyl groups in amounts of 0.54 to 1.3 milliequivalents per gram of dried resin, as shown in Table 1.

### [Formula 2]

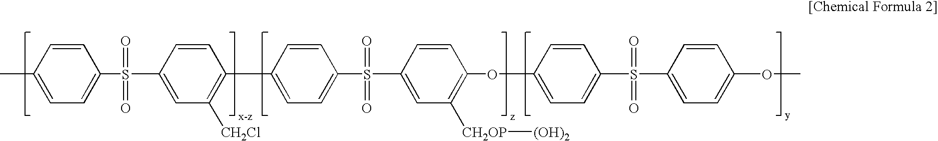

### (3) Preparation of Acetylthiodiethylphosphomethylated Polyether Sulfones

Each of the above-prepared chloromethylated diethylphosphomethylated polyether sulfones of Formula (2) was placed in a 1000-ml four-necked round-bottom flask equipped with a ref lux condenser connected with a stirrer, a thermometer, and a calcium chloride tube, and 600 ml of N-methylpyrrolidone was added. A solution of 9 g of potassium thioacetate in 50 ml of N-methylpyrrolidone (NMP) was added thereto, and the mixture was heated with stirring at 80° C. for three hours. Next, the reaction mixture was poured into 1 liter of water to precipitate polymers. The precipitates were pulverized in a mixer, were washed with water, were dried by heating, and thereby yielded acetylthiodiethylphosphomethylated polyether sulfones.

### (4) Preparation of Sulfomethylated Polyether Sulfones

Each 20 g of the above-prepared acetylthiodiethylphosphomethylated polyether sulfones was placed in a 500-ml four-necked round-bottom flask equipped with a ref lux condenser connected with a stirrer, a thermometer, and a calcium chloride tube, and 300 ml of acetic acid was added thereto. The mixture was combined with 20 ml of an aqueous hydrogen peroxide solution and was heated at 45° C. with stirring for four hours. Next, the reaction mixture was added to 1 liter of 6 N aqueous sodium hydroxide solution with cooling, and the mixture was stirred for a while.

The resulting polymers were filtered and were washed with water until no basic component was contained. The polymers were added to 300 ml of 1 N hydrochloric acid, and the mixture was stirred for a while. The polymers were then filtered, were washed with water until no acidic component was contained, were dried under reduced pressure, and thereby quantitatively yielded each 20 g of sulfomethylated diethylphosphomethylated polyether sulfones of Formula (3). These polymers were verified to contain sulfomethyl groups, because their NMR spectra show a chemical shift of methylene proton to 3.78 ppm. The polymers contain sulfomethyl groups in amounts of 0.7 to 1.5 milliequivalents per gram of dried resin, as shown in Table 1.

### [Formula 3]

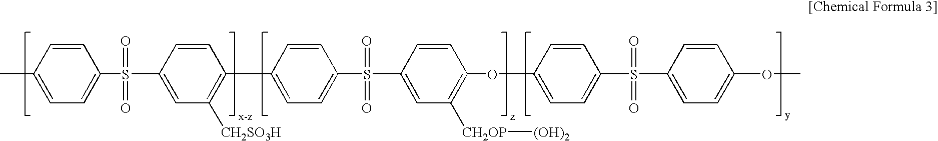

### (5) Preparation of Polymer Electrolyte Membranes and Evaluation Thereof

Each of the sulfomethyldiethylphosphomethylated polyether sulfones prepared according to the step (3) was dissolved to a concentration of 5 percent by weight in a 1:1 solvent mixture of dimethylacetamide and methoxyethanol. The solution was applied to glass by spin coating, was air-dried, was dried at 80° C. in vacuo, and thereby yielded a series of electrolyte membranes of sulfomethyldiethylphosphomethylated poly(ether sulfone)s each having a thickness of 45 μm.

The polymer electrolyte membranes have ionic conductivities at room temperature of 0.03 to 0.1 S/cm as shown in Table 1. The polymer electrolyte membranes show an increasing ionic conductivity with an increasing amount of sulfomethyl groups. In contrast, the amount of phosphomethyl groups in the membranes does not substantially affect the ionic conductivity.

In addition, the polymer electrolyte membranes were weighed (initial dry weights), were immersed in a 40 percent by weight aqueous methanol solution at 60° C. for twenty-four hours, were dried under reduced pressure, and were weighed. Differences in weight between before and after immersion were determined, and resistance (insolubility) of the polymer electrolyte membranes against an aqueous methanol solution was evaluated. The results are shown in Table 1.

The polymer electrolyte membranes according to Examples 1 to 12 showed substantially no difference in weight before and after immersion to find that they are insoluble in the aqueous methanol solution. These polymer electrolyte membranes contain phosphomethyl groups in amounts of 0.54 to 1.3 milliequivalents per gram of dried resin, and sulfomethyl groups in amounts of 0.7 to 1.5 milliequivalents per gram of dried resin. The polymer electrolyte membranes were immersed in a 3 percent by weight aqueous solution of hydrogen peroxide containing 20 ppm of ferric chloride at 80° C. for twenty-four hours, were washed with water, were dried under reduced pressure, and weights and ionic conductivities of the membranes were measured.

The oxidation resistances of the membranes were evaluated based on retentions in weight and ionic conductivity between before and after immersion, to find that they have good oxidation resistance. Specifically, the electrolyte membranes containing sulfomethyl groups and phosphomethyl groups have ionic conductivities of 0.03 S/cm or more, are highly resistant to methanol and to oxidation, and are advantageously used typically in direct-methanol fuel cells (DMFCs).

### (6) Preparation of Membrane/Electrode Assemblies (MEAs)

A slurry was prepared by mixing a catalyst powder, 30 percent by weight of a binder, and a solvent mixture of 1-propanol, 2-propanol, and methoxyethanol. The catalyst powder contained a carbon carrier and 50 percent by weight of fine particles of a 1:1 (by atomic ratio) platinum/ruthenium alloy dispersed and supported on the carbon carrier. The binder was the polymer electrolyte (sulfomethylated diethylphosphomethylated poly(ether sulfone)) prepared according to Example 12. The slurry was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols. The catalyst powder contained a carbon carrier and 30 percent by weight of platinum fine particles supported on the carbon carrier.

The binder was a solution of a poly(perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. Next, about 0.5 ml of a 5 percent by weight solution of the polymer electrolyte prepared according to Example 12 in a solvent mixture of 1-propanol, 2-propanol, and methoxyethanol was allowed to permeate the surface of the anode, and the anode was then bonded with each of the sulfomethylated poly(ether sulfone) electrolyte membranes prepared in the step (4) in Examples 1 to 12.

The resulting articles were dried at 80° C. under a load of about 1 kg for three hours. Next, about 0.5 ml of a 5 percent by weight solution of the polymer electrolyte prepared according to Example 12 in a solvent mixture of 1-propanol, 2-propanol, and methoxyethanol was allowed to permeate the surface of the cathode, and the cathode was bonded with the other side of the polymer electrolyte membranes according to Examples 1 to 12 opposite to the anode layer, so that the cathode layer overlay the anode layer with the interposition of the membrane. The resulting articles were dried at 80° C. under a load of about 1 kg for three hours and thereby yielded a series of membrane/electrode assemblies (MEAs) (1).

Anode and cathode diffusion layers were prepared in the following manner. A paste was prepared by adding 40 percent by weight in terms of weight after firing of an aqueous dispersion of polytetrafluoroethylene (PTFE) fine particles (Dispersion D-1: Daikin Industries, Ltd.) as a water repellant to carbon powder particles, and kneading the mixture. The paste was applied to one side of a carbon cloth having a thickness of about 350 μm and a porosity of 87%, was dried at room temperature, was fired at 270° C. for three hours, and thereby yielded a carbon sheet.

The amounts of the polytetrafluoroethylene (PTFE) were set to 5 to 20 percent by weight relative to the weight of the carbon cloth. The sheet was cut to the same size as the electrodes of the membrane/electrode assembly (MEA) and thereby yielded a cathode diffusion layer. A carbon cloth having a thickness of about 350 μm and a porosity of 87% was immersed in fuming sulfuric acid (concentration: 60%) in a flask and was held at a temperature of 60° C. in an atmosphere of nitrogen gas flow for two days. Next, the flask was cooled to room temperature. After removing fuming sulfuric acid, the carbon cloth was fully washed until the distilled water became neutral.

Next, the carbon cloth was immersed in methanol and was dried. The resulting carbon cloth had an infrared absorption spectrum showing absorptions derived from —OSO₃H group at 1225 cm⁻¹ and 1413 cm⁻¹, and an absorption derived from —OH group at 1049 cm⁻¹. This demonstrates that the surface of the carbon cloth bears —OSO₃H groups and —OH groups introduced thereto. In this connection, a carbon cloth not treated with fuming sulfuric acid has a contact angle with an aqueous methanol solution of 81°. The treated carbon cloth, however, had a contact angle with an aqueous methanol solution less than 81° to find to be hydrophilic. In addition, the carbon cloth was excellent in electroconductivity. The carbon cloth was cut to a piece having the same size as the electrodes of the membrane/electrode assemblies (MEAs) (1) and thereby yielded an anode diffusion layer.

### (6) Generation Performance of Fuel Cells (Direct-Methanol Fuel Cells (DMFCs))

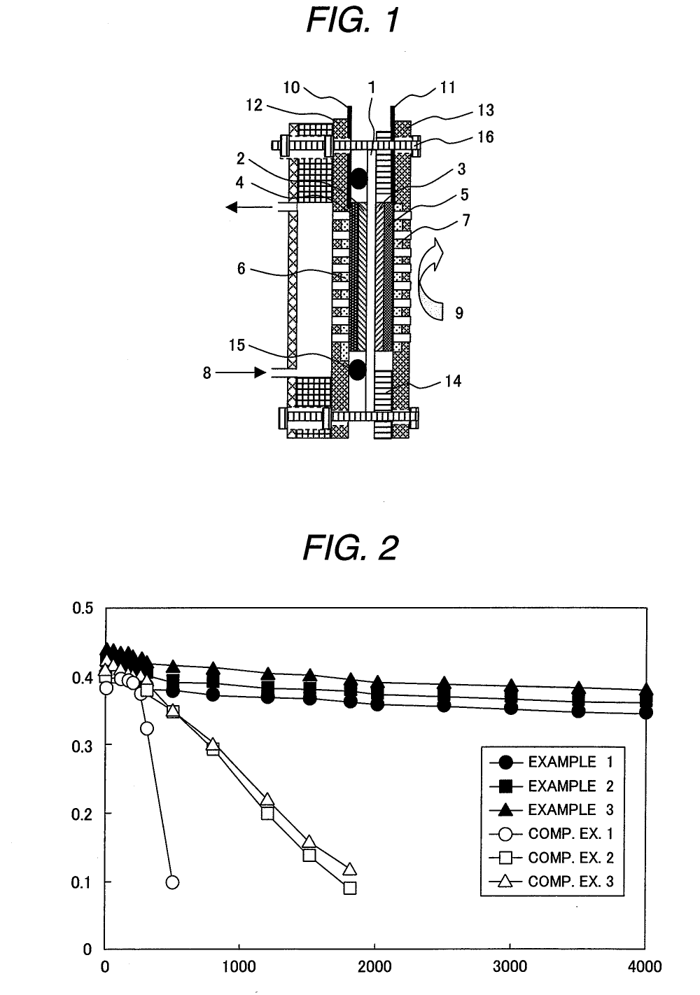

Each of the membrane/electrode assemblies (MEAs) (1) bearing the diffusion layers was mounted to a single cell of solid polymer fuel cell generator shown in FIG. 1, and the cell performance thereof was determined. FIG. 1 illustrates a polymer electrolyte membrane 1, an anode 2, a cathode 3, an anode diffusion layer 4, a cathode diffusion layer 5, an anode current collector 6, a cathode current collector 7, a fuel 8, air 9, an anode terminal 10, a cathode terminal 11, an anode end plate 12, a cathode end plate 13, a gasket 14, an O-ring 15, and bolts and nuts 16. A 20 percent by weight aqueous methanol solution as the fuel was circulated to the anode, and air was fed to the cathode. The cells were continuously operated under a load of 50 mA/cm² at 30° C. FIG. 2 shows how the output voltages of the cells according to Examples 1 to 3 vary with time. Table 1 shows the output voltages of the cells according to Examples 1 to 12 after 4000-hour operation. These direct-methanol fuel cells (DMFCs) had outputs of 0.35 V or more after 4000-hour operation and were found to work stably. These fuel cells use electrolyte membranes having sulfomethyl groups and phosphomethyl groups.

### Example 13

A fuel cell was prepared and a test was conducted by the procedure of Example 1, except for using a poly(perfluorosulfonic acid) as the binder of electrodes and as the adhesive between the electrodes and the electrolyte membrane, instead of the electrolyte according to Example 12. The cell showed an output of 0.34 V after operating under a load of 50 mA/cm² at 30° C. for 4,000 hours and was found to work stably.

TABLE 1

| | | | | | | | | Dis- | | | |
|---|---|---|---|---|---|---|---|---|---|---|---|
| | | | | | | | | solution | | | |
| | | | | | | | | loss in | | | |
| | | | | | | | | 40 wt % | | | Output |
| | | | | | | | | aqueous | | | voltage |
| | | | Amount (meq/g-dried resin) | | | | | methanol | Oxidation resistance | | after |
| | Chloromethyl | | | | | Phos- | | solution at | Weight | Ionic | 4000-hour |
| | methyl | Reaction | Sul- | Sulfo- | Phospho- | phonic | Ionic | 60° C. | retention | conductivity | operation |
| | ether | time | fonic | methyl | methyl | acid | conductivity | (% by | (% by | retention | at 50 mA/cm² |
| | (ml) | (hrs) | group | group | group | group | (S/cm) | weight) | weight) | (%) | (V) |
| Ex. 1 | 40 | 96 | 0.00 | 0.90 | 0.54 | 0.00 | 0.03 | 0 | 100 | 97 | 0.35 |
| Ex. 2 | 47 | 120 | 0.00 | 1.16 | 0.60 | 0.00 | 0.04 | 0 | 100 | 100 | 0.36 |
| Ex. 3 | 50 | 120 | 0.00 | 1.25 | 0.55 | 0.00 | 0.07 | 0 | 100 | 100 | 0.38 |
| Ex. 4 | 50 | 120 | 0.00 | 1.15 | 0.65 | 0.00 | 0.04 | 0 | 100 | 100 | 0.36 |
| Ex. 5 | 50 | 120 | 0.00 | 1.10 | 0.70 | 0.00 | 0.04 | 0 | 100 | 100 | 0.37 |
| Ex. 6 | 50 | 120 | 0.00 | 1.00 | 0.80 | 0.00 | 0.04 | 0 | 100 | 100 | 0.36 |
| Ex. 7 | 50 | 120 | 0.00 | 0.90 | 0.90 | 0.00 | 0.03 | 0 | 100 | 100 | 0.36 |
| Ex. 8 | 50 | 120 | 0.00 | 0.70 | 1.10 | 0.00 | 0.03 | 0 | 100 | 100 | 0.36 |
| Ex. 9 | 66 | 144 | 0.00 | 1.25 | 1.10 | 0.00 | 0.07 | 0 | 100 | 100 | 0.38 |
| Ex. 10 | 66 | 144 | 0.00 | 1.35 | 1.00 | 0.00 | 0.08 | 0 | 100 | 100 | 0.39 |
| Ex. 11 | 70 | 144 | 0.00 | 1.50 | 1.00 | 0.00 | 0.10 | 0 | 100 | 100 | 0.38 |
| Ex. 12 | 70 | 144 | 0.00 | 1.50 | 1.30 | 0.00 | 0.10 | 0 | 100 | 100 | 0.40 |
| Ex. 13* | 40 | 96 | 0.00 | 0.90 | 0.54 | 0.00 | 0.03 | 0 | 100 | 97 | 0.34 |
| Ex. 14 | 17 | 96 | 0.90 | 0.00 | 0.60 | 0.00 | 0.03 | 10 | 110 | 100 | 0.18 |
| Ex. 15 | 125 | 96 | 1.10 | 0.00 | 0.90 | 0.00 | 0.04 | 10 | 120 | 100 | 0.15 |
| Ex. 16 | 20 | 96 | 1.25 | 0.00 | 0.70 | 0.00 | 0.07 | 15 | 130 | 100 | 0.10 |
| Com. Ex. 1 | — | — | 1.10 | 0.00 | 0.00 | 0.00 | 0.04 | 1 | 0 | — | 0.00 |
| Com. Ex. 2 | — | — | 0.00 | 0.10 | 0.00 | 0.00 | 0.04 | 0 | 0 | — | 0.00 |
| Com. Ex. 3 | — | — | 1.10 | 0.00 | 0.00 | 0.40 | 0.06 | 35 | 65 | 50 | 0.00 |

*Poly(perfluorosulfonic acid) was used as a binder and an adhesive.

### Comparative Example 1

### (1) Preparation of Membrane/Electrode Assembly (MEA)

A slurry was prepared by mixing a catalyst powder, 30 percent by weight of a poly(perfluorosulfonic acid) electrolyte as a binder, and a solvent mixture of water and alcohols (a 20:40:40 (by weight) solvent mixture of water, isopropyl alcohol, and n-propanol). The catalyst powder used herein included 50 percent by weight of fine particles of a 1:1 (by atomic ratio) platinum/ruthenium alloy dispersed on and supported by a carbon carrier. The slurry was applied to a polyimide film by screen printing and thereby yielded an anode having a thickness of about 125 μm, a width of 30 mm, and a length of 30 mm. Next, another slurry was prepared by mixing a catalyst powder, 30 percent by weight of a binder, and a solvent mixture of water and alcohols.

The catalyst powder contained a carbon carrier and 30 percent by weight of platinum fine particles supported on the carbon carrier. The binder was a poly(perfluorosulfonic acid). The slurry was applied to a polyimide film by screen printing and thereby yielded a cathode having a thickness of about 20 μm, a width of 30 mm, and a length of 30 mm. About 0.5 ml of a 5 percent by weight solution of a poly(perfluorosulfonic acid) in a solvent mixture (a 20:40:40 (by weight) solvent mixture of water, isopropyl alcohol, and n-propanol) was allowed to permeate the surface of the anode, and the anode was bonded with an electrolyte membrane, and was dried at 80° C. under a load of 1 kg for three hours.

The electrolyte membrane contained a sulfonated poly(ether sulfone) having a sulfonic acid equivalent of 1.1 milliequivalents per gram of dried resin. Next, about 0.5 ml of a 5 percent by weight solution of a poly(perfluorosulfonic acid) in a solvent mixture of 1-propanol, 2-propanol, and methoxyethanol was allowed to permeate the surface of the cathode. The cathode was then bonded with the other side of the polymer electrolyte membrane opposite to the anode layer, so that the cathode layer overlay the anode layer with the interposition of the membrane.

The resulting article was dried at 80° C. under a load of about 1 kg for three hours and thereby yielded a membrane/electrode assembly (MEA) (2).

The membrane/electrode assembly (MEA) (2) was combined with the hydrophilized carbon cloth as an anode diffusion layer, and the water-repellent carbon cloth as a cathode diffusion layer. The hydrophilized carbon cloth and the water-repellent carbon cloth were prepared in Example 1.

### (2) Generation Performance of Fuel Cell (Direct-Methanol Fuel Cell (DMFC))

The membrane/electrode assembly (MEA) (2) bearing the diffusion layers was mounted to a single cell of solid polymer fuel cell generator shown in FIG. 1, and the cell performance thereof was determined. A 20 percent by weight aqueous methanol solution as the fuel was circulated to the anode, and air was fed to the cathode. The cell was continuously operated under a load of 50 mA/cm² at 30° C. FIG. 2 shows how the output voltage of the cell varies with time in the test. After operating for 400 hours, the output voltage decreased to 0.22 V.

These results demonstrate that fuel cells using hydrocarbon electrolyte membranes containing sulfoalkyl groups and phosphoalkyl groups can stably yield satisfactory outputs over extended periods of time, in contrast to a fuel cell using a polymer electrolyte membrane having sulfonic groups. The results also demonstrate that fuel cells using a hydrocarbon electrolyte having sulfoalkyl groups and phosphoalkyl groups as a binder in electrodes can exhibit durability equal to or higher than that of a fuel cell using a fluorine-containing electrolyte as the binder.

### Comparative Example 2

A fuel cell was prepared and a test was conducted by the procedure of Comparative Example 1, except for using an electrolyte membrane of a sulfomethylated poly(ether sulfone) having a sulfonic acid equivalent of 1.2 milliequivalents per gram of dried resin, instead of the sulfonated poly(ether sulfone) electrolyte membrane. A 20 percent by weight aqueous methanol solution as the fuel was circulated to the anode, and air was fed to the cathode. The cell was continuously operated under a load of 50 mA/cm² at 30° C. FIG. 2 shows how the output voltage of the cell varies with time in the test. After operating for 1400 hours, the cell showed a reduced output voltage of 0.14 V.

These results demonstrate that fuel cells using hydrocarbon electrolyte membranes containing both sulfoalkyl groups and phosphoalkyl groups can stably yield satisfactory outputs over extended periods of time, in contrast to a fuel cell using a polymer electrolyte membrane having sulfoalkyl groups alone. They also demonstrate that fuel cells using a hydrocarbon electrolyte having sulfoalkyl groups and phosphoalkyl groups as a binder in electrodes can exhibit durability equal to or higher than that of a fuel cell using a fluorine-containing electrolyte as the binder.

### Comparative Example 3

A fuel cell was prepared and a test was conducted by the procedure of Comparative Example 1, except for using an electrolyte membrane of a sulfonated phosphonated poly(ether sulfone) having a sulfonic acid equivalent of 1.2 milliequivalents per gram of dried resin, instead of the sulfonated poly(ether sulfone) electrolyte membrane. A 20 percent by weight aqueous methanol solution as the fuel was circulated to the anode, and air was fed to the cathode. The fuel cell was continuously operated under a load of 50 mA/cm² at 30° C. FIG. 2 shows how the output voltage of the cell varies with time in the test. After 1400-hour operation, the output voltage of the fuel cell decreased to 0.14 V.

These results demonstrate that fuel cell using hydrocarbon electrolyte membranes containing both sulfoalkyl groups and phosphoalkyl groups can stably yield satisfactory outputs over extended periods of time, in contrast to a fuel cell using a polymer electrolyte membrane having sulfonic groups and phosphonic groups. They also demonstrate that a fuel cell using a hydrocarbon electrolyte having sulfoalkyl groups and phosphoalkyl groups as a binder in electrodes can exhibit durability equal to or higher than that of a fuel cell using a fluorine-containing electrolyte.

### Examples 14 to 16

### (1) Preparation of Sulfonated Chloromethylated Polyether Sulfones

A 500-ml four-necked round-bottom flask used herein was equipped with a reflux condenser connected with a stirrer, a thermometer, and a calcium chloride tube. After replacing the inner atmosphere of the flask with nitrogen, 30 g of each sulfonated poly(ether sulfone)s having sulfonic acid equivalents of 0.9, 1.1, and 1.25 milliequivalents per gram of dried resin, respectively, and 250 ml of carbon disulfide were placed in the flask. After adding chloromethyl methyl ether in amounts shown in Table 1, a solution containing 1 ml of anhydrous tin(IV) chloride in 20 ml of carbon disulfide was added dropwise, and the mixture was heated at 46° C. with stirring for the reaction time periods shown in Table 1. Next, the reaction mixtures were poured into 1 liter of methanol to precipitate polymers. The precipitates were pulverized in a mixer, were washed with methanol, and thereby yielded sulfonated chloromethylated poly(ether sulfone)s.

### (2) Preparation of Sulfonated Diethylphosphomethylated Poly(Ether Sulfone)s

Each of the sulfonated chloromethylated poly(ether sulfone)s was immersed in triethyl ester of phosphonic acid and was subjected to heating under reflux for twelve hours. The reaction mixtures were poured into ethanol to precipitate polymers. The precipitates were pulverized in a mixer, were washed with ethanol, and thereby yielded sulfonated diethylphosphomethylated poly(ether sulfone)s. These polymers contained phosphomethyl groups in amounts of 0.6 to 0.9 milliequivalents per gram of dried resin, as shown in Table 1.

### (3) Preparation of Polymer Electrolyte Membranes and Evaluation Thereof

Each of the sulfonated diethylphosphomethylated poly(ether sulfone) s prepared in the step (2) was dissolved to a concentration of 5 percent by weight in a 1:1 solvent mixture of dimethylacetamide and methoxyethanol. The solution was applied to glass by spin coating, was air-dried, was dried in vacuo at 80° C., and thereby yielded a series of electrolyte membranes of sulfonated diethylphosphomethylated poly(ether sulfone) shaving a thickness of 45 μm. The polymer electrolyte membranes have ionic conductivities at room temperature of 0.03 to 0.07 S/cm as shown in Table 1. They show an increasing ionic conductivity with an increasing amount of sulfonic groups. In contrast, the amount of phosphomethyl groups in the membranes does not substantially affect the ionic conductivity.

In addition, the polymer electrolyte membranes were weighed (initial dry weights), were immersed in a 40 percent by weight aqueous methanol solution at 60° C. for twenty-four hours, were dried under reduced pressure, and were weighed. Differences in weight between before and after immersion were determined, and resistance (insolubility) of the polymer electrolyte membranes against an aqueous methanol solution was evaluated. The results are shown in Table 1. The polymer electrolyte membranes according to Examples 14 and 15 showed weight loss after immersion of 10% to 15% to find that they are substantially insoluble in the aqueous methanol solution. These polymer electrolyte membranes have phosphomethyl groups in amounts of 0.6 to 0.9 milliequivalents per gram of dried resin, and sulfonic groups in amounts of 0.9 to 1.25 milliequivalents per gram of dried resin. The polymer electrolyte membranes were immersed in a 3 percent by weight aqueous solution of hydrogen peroxide containing 20 ppm of ferric chloride at 0° C. for twenty-four hours, were washed with water, were dried under reduced pressure, and weights and ionic conductivities of the membranes were measured. The oxidation resistances of the membranes were evaluated based on retentions in weight and ionic conductivity. The polymer electrolyte membranes each show good oxidation resistance. Superficially, the electrolyte membranes containing sulfonic groups and phosphomethyl groups retain ionic conductivities of 0.03 S/cm or more and are highly resistant to oxidation. They, however, show resistance to (insolubility in) methanol somewhat inferior to that of the electrolyte membranes having sulfoalkyl groups and phosphoalkyl groups (sulfomethyl groups and phosphomethyl groups).

### (4) Preparation of Membrane/Electrode Assemblies (MEAs)

A slurry was prepared by mixing a catalyst powder, 30 percent by weight of a binder, and a solvent mixture of 1-propanol, 2-propanol, and methoxyethanol. The catalyst powder contained 50 percent by weight of fine particles of a 1:1 (by atomic ratio) platinum/ruthenium alloy dispersed on and supported by a carbon carrier. The binder was the polymer electrolyte (sulfomethylated diethylphosphomethylated poly(ether sulfone)) prepared according to Example 12. The slurry was applied to a polyimide film by screen printing and thereby yielded an anode having a thickness of about 125 μm, a width of 30 mm, and a length of 30 mm. Next, another slurry was prepared by mixing a catalyst powder, a binder, and a solvent mixture of water and alcohols. The catalyst powder contained a carbon carrier and 30 percent by weight of platinum fine particles supported on the carbon carrier. The binder was a solution of a poly(perfluorosulfonic acid) in a solvent mixture of 1-propanol, 2-propanol, and methoxyethanol. The slurry was applied to a polyimide film by screen printing and thereby yielded a cathode having a thickness of about 20 μm, a width of 30 mm, and a length of 30 mm. Next, about 0.5 ml of a 5 percent by weight solution of the polymer electrolyte prepared according to Example 12 in a solvent mixture of 1-propanol, 2-propanol, and methoxyethanol was allowed to permeate the surface of the anode, and the anode was then bonded with each of the sulfonated diethylphosphomethylated poly(ether sulfone) electrolyte membranes prepared in the step (3) in Examples 14 to 16. The resulting articles were dried at 80° C. under a load of about 1 kg for three hours. Next, about 0.5 ml of a 5 percent by weight solution of the polymer electrolyte prepared according to Example 12 in a solvent mixture of 1-propanol, 2-propanol, and methoxyethanol was allowed to permeate the surface of the cathode, and the cathode was bonded with the other side of the sulfonated diethylphosphomethylated poly(ether sulfone) electrolyte membranes opposite to the anode layer, so that the cathode layer overlay the anode layer with the interposition of the membrane. The resulting articles were dried at 80° C. under a load of about 1 kg for three hours and thereby yielded a series of membrane/electrode assemblies (MEAs) (3).

Anode and cathode diffusion layers were prepared in the following manner. A paste was prepared by adding 40 percent by weight in terms of weight after firing of an aqueous dispersion of polytetrafluoroethylene (PTFE) fine particles (Dispersion D-1: Daikin Industries, Ltd.) as a water repellant to carbon powder particles, and kneading the mixture. The paste was applied to one side of a carbon cloth having a thickness of about 350 μm and a porosity of 87%, was dried at room temperature, was fired at 270° C. for three hours, and thereby yielded a carbon sheet. The amounts of the polytetrafluoroethylene (PTFE) were set to 5 to 20 percent by weight relative to the weight of the carbon cloth. The sheet was cut to the same size with the electrodes of the membrane/electrode assemblies (MEAs) (3) and thereby yielded a cathode diffusion layer.

A carbon cloth having a thickness of about 350 μ, and a porosity of 87% was immersed in fuming sulfuric acid (concentration: 60%) in a flask and held at a temperature of 60° C. in an atmosphere of nitrogen gas flow for two days. Next, the flask was cooled to room temperature. After removing fuming sulfuric acid, the carbon cloth was fully washed until the distilled water became neutral. Next, the carbon cloth was immersed in methanol and was dried. The resulting carbon cloth had an infrared absorption spectrum showing absorptions derived from —OSO₃H group at 1225 cm⁻¹ and 1413 cm⁻¹, and an absorption derived from —OH group at 1049 cm⁻¹. This demonstrates that the surface of the carbon cloth bears —OSO₃H groups and —OH groups introduced thereto. In this connection, a carbon cloth not treated with fuming sulfuric acid has a contact angle with an aqueous methanol solution of 81°.

The treated carbon cloth, however, had a contact angle with an aqueous methanol solution less than 81° to find to be hydrophilic. In addition, the carbon cloth was excellent in electroconductivity. The carbon cloth was cut to a piece having the same size as the electrodes of the membrane/electrode assembly (MEA) (1) and thereby yielded an anode diffusion layer.

### (5) Generation Performance of Fuel Cells (Direct-Methanol Fuel Cells (DMFCs))

Each of the membrane/electrode assemblies (MEAs) (3) bearing the diffusion layers was mounted to a single cell of solid polymer fuel cell generator shown in FIG. 1, and the cell performance thereof was determined. FIG. 1 illustrates a polymer electrolyte membrane 1, an anode 2, a cathode 3, an anode diffusion layer 4, a cathode diffusion layer 5, an anode current collector 6, a cathode current collector 7, a fuel 8, air 9, an anode terminal 10, a cathode terminal 11, an anode end plate 12, a cathode end plate 13, a gasket 14, an O-ring 15, and bolts and nuts 16.

A 20 percent by weight aqueous methanol solution as the fuel was circulated to the anode, and air was fed to the cathode. The cells were continuously operated under a load of 50 mA/cm² at 30° C. FIG. 2 shows how the output voltages change with time in Examples 1 to 3. Table 1 shows the output voltages of the cells according to Examples 1 to 12 after 4000-hour operation. These direct-methanol fuel cells (DMFCs) had outputs of 0.10 V or more after 4000-hour operation. The direct-methanol fuel cells (DMFCs) use electrolyte membranes having sulfonic groups and phosphomethyl group and show properties somewhat inferior to those of the direct-methanol fuel cells (DMFCs) using electrolyte membranes having sulfoalkyl groups and phosphomethyl groups.

### Example 17

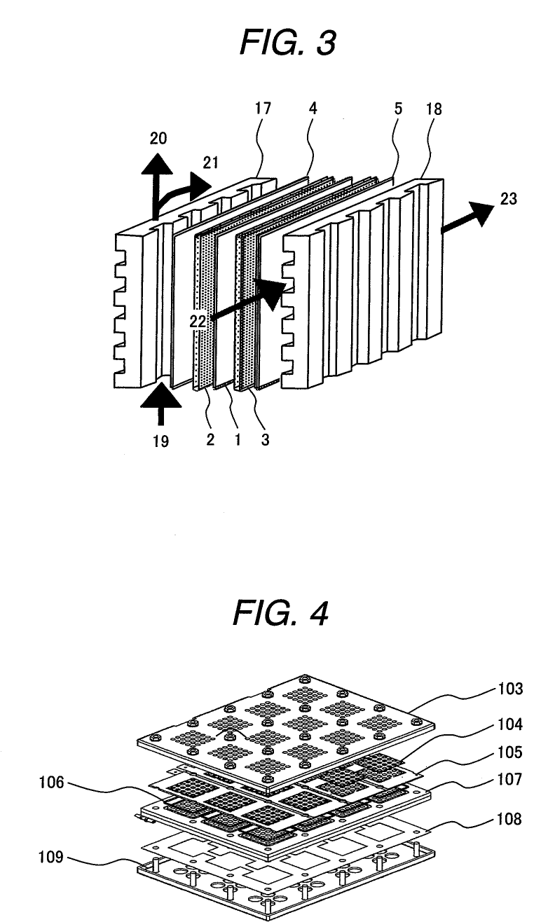

The membrane/electrode assembly (MEA) (1) bearing the diffusion layers according to Example 1 was mounted to a compact single cell shown in FIG. 3 using hydrogen as a fuel, and the cell performance thereof was determined. FIG. 3 illustrates a polymer electrolyte membrane 1, an anode 2, a cathode 3, an anode diffusion layer 4, a cathode diffusion layer 5, a fuel pathway 17 of an electroconductive separator (bipolar plate) acting to separate electrode chambers and serving as a gas feed passage to the electrodes, an air pathway 18 of an electroconductive separator (bipolar plate) acting to separate electrode chambers and serving as a gas feed passage to the electrodes, a flow 19 of hydrogen and water, hydrogen 20, water 21, air 22, and a flow 23 of air and water.

The compact single cell was placed in a thermostatic bath, and the temperature of the thermostat bath was controlled so that a temperature measured by a thermocouple (not shown) placed in the separator stood at 70° C. The anode and cathode were humidified using an external humidifier, and the temperature of the humidifier was controlled within a range of 70° C. to 73° C. so that a dew point in the vicinity of an outlet of the humidifier stood at 70° C. The dew point was determined using a dew-point temperature sensor. In addition, the consumption of the humidifying water was continuously measured so as to verify that a dew point as determined from the flow rate, temperature, and pressure of reaction gas was a predetermined value.

The fuel cell was allowed to generate electricity for about eight hours a day under a load at a current density of 250 mA/cm², a hydrogen utilization of 70%, and an air utilization of 40% and to operate while keeping it hot during the remainder periods of time. Even after 7,000 hours, the fuel cell had an output voltage of 94% or more of the initial voltage. This demonstrates that a membrane/electrode assembly according to an embodiment of the present invention is highly durable when used in a fuel cell using hydrogen as a fuel.

### Example 18

### (1) Preparation of Fuel Cell

FIG. 4 shows the assemblage of a fuel cell 101 using the membrane/electrode assembly prepared according to Example 1, by way of example. The fuel cell 101 was assembled by sequentially integrating a cathode end plate 103, a cathode current collector 104, a section 105 housing the membrane/electrode assembly (MEA) bearing diffusion layers prepared according to Example 1, a packing 106, an anode end plate 107, a fuel tank 108, and an anode end plate 109 in this order using bolts and nuts.

### (2) Preparation of Fuel Cell Power Source System

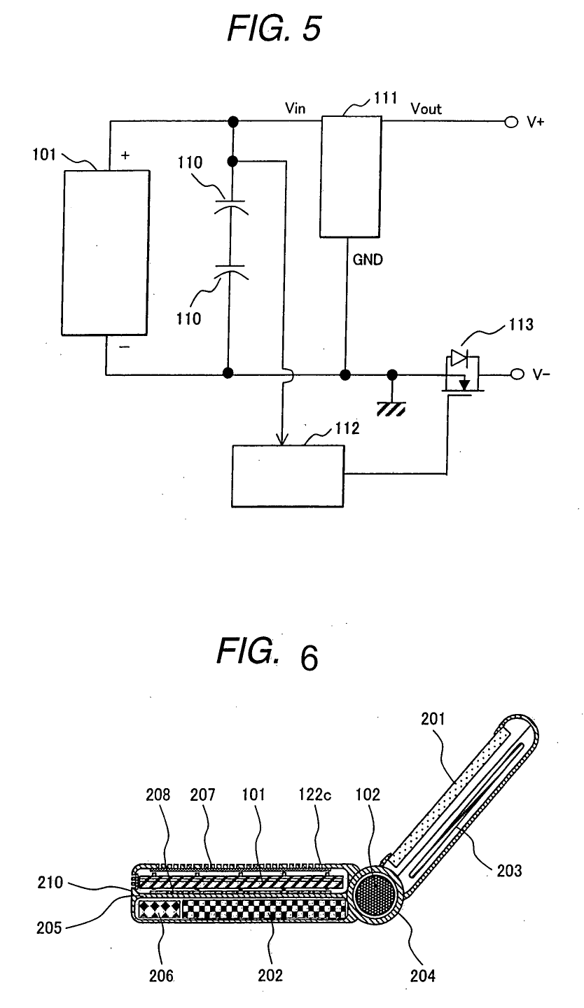

FIG. 5 illustrates an example of a power source system including the fuel cell 101. FIG. 5 illustrates the fuel cell 101, an electric double layer capacitor 110, a DC to DC converter 111, a load rejection switch 113, and a sensor/controller 112 configured to control ON/OFF of the load rejection switch 113. The power source illustrated in FIG. 5 includes electric double layer capacitors arrayed in series in two rows. The power source is configured in the following manner.

The fuel cell 101 generates electricity, and the electric double layer capacitor 110 temporarily stores the electricity. The sensor/controller 112 determines the electricity in the electric double layer capacitor and allows the load rejection switch 113 to turn ON when a predetermined quantity of electricity is stored in the capacitor. The electricity is increased to a predetermined voltage by the action of the DC to DC converter and is then fed to an electronic device.

### (3) Preparation of Personal Digital Assistant

FIG. 6 illustrates a personal digital assistant including the fuel cell power source prepared in the step (2) byway of example. The personal digital assistant has a foldable structure including two units connected through a hinge with cartridge holder 204 serving also as a holder of a fuel cartridge 2. One of the two units includes an antenna 203 and a display unit 201 integrated with a touch-sensitive panel input device. The other unit includes the fuel cell 101, a motherboard 202, and a lithium ion secondary battery 206.

The motherboard 202 includes electronic elements and electronic circuits such as processors, volatile and nonvolatile memories, an electric power controller, a hybrid controller for the fuel cell and the secondary battery, and a fuel monitor. In this example, an auxiliary power source for the fuel cell is a lithium ion secondary battery 206. The auxiliary power source can also be, for example, a nickel hydrogen cell or an electric double layer capacitor.

The section housing the power source is partitioned by a partitioning plate 205 into a lower part and an upper part. The lower part houses the motherboard 202 and the lithium ion secondary battery 206, and the upper part houses the fuel cell power source 101. The upper and side walls of the cabinet have slits 122c for diffusing air and fuel exhaust gas. An air filter 207 is arranged on surface of the slits 122c in the cabinet, and a water-absorptive quick-drying material 208 is arranged on surface of the partitioning plate 205.

The air filter may include any material that is capable of satisfactorily diffusing gases and capable of preventing entry of dust. The air filter is preferably a mesh or woven fabric containing a single yarn of a synthetic resin, because such a filter is resistant to clogging. A single yarn mesh of a water-repellent polytetrafluoroethylene, for example, may be used. The personal digital assistant stably operated over 2,000 hours or longer.

Direct-methanol fuel cells (DMFCs) using hydrocarbon electrolyte membranes in related art undergo reduction in thickness and breakage in the cathode of electrolyte membrane, show reduced cell performance and become incapable of generating electricity after several hundreds of hours from the beginning of fuel supply. The present inventors found that this can be effectively avoided by introducing a sulfonic group and a phosphonic acid group into a hydrocarbon polymer electrolyte membrane for imparting proton conductivity and oxidation resistance, respectively.

However, they also found that such a hydrocarbon electrolyte membrane becomes more soluble in a fuel aqueous methanol solution with an increasing amount of phosphonic acid groups, and that the resulting hydrocarbon electrolyte membrane may not be suitably used in direct-methanol fuel cells (DMFCs). Accordingly, they made intensive investigations. According to an embodiment of the present invention, a sulfoalkyl group or sulfonic group as a proton-conductive group, and a phosphoalkyl group as an oxidation-resistance imparting group are introduced into a hydrocarbon electrolyte membrane. Thus, there is provided a fuel cell that is resistant to dissolution in an aqueous methanol solution as a fuel and can stably generate electricity over extended periods of time.

According to another embodiment, a sulfoalkyl group or sulfonic group as a proton-conductive group, and a phosphoalkyl group as an oxidation-resistance imparting group are introduced into a hydrocarbon electrolyte, and the resulting hydrocarbon electrolyte is used as an electrolyte of an electrode. Thus, there is provided a direct-methanol fuel cell (DMFC) that is inexpensive and can operate stably over extended periods of time.

A direct-methanol fuel cell power source using a membrane/electrode assembly according to an embodiment of the present invention may be used as a battery charger for electronic devices having secondary batteries, or as an integrated power source for electronic devices using no secondary battery. Such electronic devices include, for example, mobile phones, mobile personal computers, mobile audio/visual devices, and other personal digital assistants. The resulting electronic devices can be used over extended periods of time and can be continuously used by refueling. A solid polymer fuel cell using hydrogen as a fuel and including a membrane/electrode assembly according to an embodiment of the present invention can be used as a household or business cogeneration dispersed power source or a fuel cell power source for mobile use. The resulting apparatuses can be used over extended periods of time, and can be continuously used by refueling.

What is claimed is:

1. A hydrocarbon polymer electrolyte having proton-conductive groups and phosphoalkyl groups.

2. The hydrocarbon polymer electrolyte according to claim 1, wherein the proton-conductive groups are sulfoalkyl group.

3. A hydrocarbon polymer electrolyte membrane comprising a hydrocarbon polymer electrolyte having proton-conductive groups and phosphoalkyl groups.

4. A membrane/electrode assembly comprising a cathode; an anode; and a polymer electrolyte membrane arranged between the cathode and the anode, wherein the polymer electrolyte membrane is the hydrocarbon polymer electrolyte membrane of claim 3.

5. A fuel cell comprising a cathode; an anode; and a polymer electrolyte membrane arranged between the cathode and the anode, wherein the polymer electrolyte membrane has proton-conductive groups and phosphoalkyl groups.

6. A fuel cell power source system comprising the fuel cell of claim 5; and an auxiliary power source.

7. An electronic device to which the fuel cell of claim 5 is installed.
